(19) United States
(12) Patent Application Publication
(10) Pub. No.: US 2013/0331417 A1
(43) Pub. Date: Dec. 12, 2013

(54) INSECTICIDAL MIXTURES WITH IMPROVED PROPERTIES

(71) Applicants: Peter Jeschke, Bergisch Gladbach (DE); Robert Velten, Langenfeld (DE); Britta Olenik, Bottrop (DE); Heike Hungenberg, Langenfeld (DE)

(72) Inventors: Peter Jeschke, Bergisch Gladbach (DE); Robert Velten, Langenfeld (DE); Britta Olenik, Bottrop (DE); Heike Hungenberg, Langenfeld (DE)

(73) Assignee: BAYER INTELLECTUAL PROPERTY GMBH, Monheim (DE)

(21) Appl. No.: 13/992,496

(22) PCT Filed: Dec. 5, 2011
(86) PCT No.: PCT/EP2011/071757

§ 371 Date: Aug. 30, 2013

(30) Foreign Application Priority Data
Dec. 9, 2010 (EP) 10194366.0

(51) Int. Cl. A01N 43/40; A01N 43/50; A01N 43/38

(52) U.S. Cl. CPC A01N 43/40; A01N 43/38; A01N 43/50
USPC 514/341; 514/336

(57) ABSTRACT

The present invention relates to novel pesticidal compositions comprising the crystalline modification I of 4-{[(6-chloropyrid-3-yl)methyl](methyl)amino} furan-2(5H)-one and a insecticide, acaricide or nematicide that show surprisingly good insecticidal, acaricidal, nematicidal and fungicidal activities. In particular, these compositions are suited for the treatment of seed.

The present invention relates to active compound combinations, mixtures or compositions comprising the thermodynamically stable crystalline modification I of 4-{[(6-chloropyrid-3-yl)methyl](methyl)amino} furan-2(5H)-one and at least one insecticide, acaricides or nematicide to combat unwanted pests which occur in the agrochemical field. The invention moreover related to their use in agrochemical preparations (formulations).

The compound 4-{[(6-chloropyrid-3-yl)methyl](methyl)amino} furan-2(H5)-one, having the chemical formula (I) has been firstly described in EP-A-0 539 588.

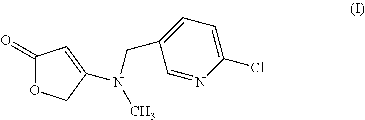 [SMILES: CN(Cc1ccc(Cl)nc1)C1=CC(=O)OC1]

The compounds described in EP-A-0 539 588 are supposed to provide insecticidal activity against various harmful insects. From WO 2006/037475 it is known that a compound of formula (I) can be used for seed treatment, for controlling pests which occure in the veterinary medicine, or for protecting materials.

EP-A-0 539 588 suggests to use one of the compounds described therein in combination with selected acaricides, fungicides and insecticides without giving biological data

From several patent publications it is known to combine the compound of formula I, namely 4-{[(6-chloropyrid-3-yl)methyl](methyl)amino} furan-2(5H)-one with different types of insecticides (cf. WO 2007/112848, WO 2007/112845, WO 2007/112843, WO 2007/112842, WO 2007/112847, WO 2007/112895, WO 2007/112894).

From WO 2008/040445 it is known that the compound of formula (I), namely 4-{[(6-chloropyrid-3-yl)methyl](methyl)amino} furan-2 (5H-one exists in two crystalline modifications, namely a thermodynamically stable crystalline modification I and a metastable crystalline modification II. The characterization of the crystalline modifications has been done by using X-ray powder diffraction, when using Cu Ka radiation, and the detection of the reflection planes (2 theta, >20% relative intensity). In view of the characterization of the crystalline modification I, WO 2008/040445 is hereby incorporated by reference.

WO 2008/040445 describes the advantage of the crystalline modification I as having favorable physicochemical properties so that the compound can be handled well in formulations, particularly in such formulations which require grinding processes. Such formulations are, for example, granules, encapsulated granules, tablets, water-dispersible granules, water-dispersible tablets, water-dispersible powders or water-dispersible powders for seed treatment, dust formulations, and formulations in which the active compound is present in dispersed form, such as, for example: Suspension concentrates, oil-based suspension concentrates, suspoemulsions, or suspension concentrates for seed treatment.

WO 2008/040445 also describes that 4-{[(6-chloropyrid-3-yl)methyl](methyl)amino} furan-2(5H)-one can be present in its commercially available formulations and in the use forms, prepared from these formulations, as a mixture with other active compounds, such as insecticides, attractants, sterilizing agents, bactericides, acaricides, nematicides, fungicides, growth-regulating substances, herbicides, safeners, fertilizers or semiochemicals. It further generally describes that a synergistically increased activity of the compositions might occur and which exceeds the expected activity of the active compounds when applied individually.

The inventors now found that by combining the crystalline modification I of 4-{[(6-chloropyrid-3-yl)methyl](methyl)amino} furan-2(5H)-one as described in WO 2008/040445 with selected insecticides an increased synergistic insecticidal activity was achieved which, additionally, proved to be stable over a certain time.

The crystalline modification I of 4-{[(6-chloropyrid-3-yl)methyl](methyl)amino} furan-2(5H)-one is characterized in that it has an X-ray powder diffractogram, when using Cu Kα radiation, with the following reflections (>20% relative intensity): 16.80°, 19.58°, 21.11°, 21.32°, 22.92°, 23.23°, 23.97° and 28.00° (in each case ±0.2°) 2 theta. (¹Intensity relative to the most intensive signal of the diffractogram which is arbitrarily defined as 100). All X-ray powder diffractometry data were obtained using the following acquisition parameters: Diffractometer: Transmission, Monochromator: Curved Germanium (111), Wave length: 1.540598 Cu, Detector: Linear PSD, Scan mode: Transmission/Moving PSD/Fixed omega, Scan type: Theta: Omega, 2 theta stated: ±0.2°.

The finding is important since there is a constant need to develop novel pesticidal compounds and compound combinations which show an excellent action against a wide variety of pests, fungi and/or microorganisms. From an ecological stand point it is desirable to find highly active compound combinations so that the application rate (dosage) can be reduced. Additionally, by using combinations of active compounds, a substantial broadening of the spectrum of pests, fungi and/or microorganisms that can be controlled, including resistant pests and fungi, can be achieved. Additionally, it may become possible to combat pests, fungi and/or microorganisms at different developmental stages. Compound combinations may also lead to a reduced phytotoxicity of the compounds and thus to better tolerance of the compounds by plants.

Using a crystalline modification of a compound can result in a better behavior of the chemicals during production of the application form (usually agrochemical formulations). The grinding or mixing can be improved and the shelf life can be increased.

Thus, the invention is directed to an active compound combination, a mixture or a composition comprising the crystalline modification I of 4-{[(6-chloropyrid-3-yl)methyl](methyl)amino} furan-2(5H)-one as characterized in WO 2008/040445 and one of the following known insecticides, acaricides or nematicides of group (A), which is comprised of compounds from the following sub-groups (1) to (29):

(1) Acetylcholinesterase (AChE) inhibitors, for example carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC, and xylylcarb; or organophosphates, e.g. acephate, azamethiphos, azinphos (-methyl, -ethyl), cadusafos, chlorethoxyfos, chlorfenvinphos, chlorfenvinphos, chlormephos, chlorpyrifos (-methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos (-methyl), profenofos, propetamphos, prothiofos, pyraclofos, pyridaphenthion, quinalphos, sulfotep, tebupirimfos, temephos, terbufos, tetrachlorvinphos, thiometon, triazophos, triclorfon, and vamidothion.

(2) GABA-gated chloride channel antagonists, for example organochlorines, e.g. chlordane, endosulfan (alpha-); or fiproles (phenylpyrazoles), e.g. ethiprole, fipronil, pyrafluprole, and pyriprole.

(3) Sodium channel modulators/voltage-dependent sodium channel blockers, for example pyrethroids, e.g. acrinathrin, allethrin (d-cis-trans, d-trans), bifenthrin, bioallethrin, bioallethrin S-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans-isomers], deltamethrin, dimefluthrin, empenthrin [(EZ)-(1R)-isomers), esfenvalerate, etofenprox, fenpropathrin, fenvalerate, flucythrinate, flumethrin, fluvalinate (tau-), halfenprox, imiprothrin, metofluthrin, permethrin, phenothrin [(1R)-trans-isomer), prallethrin, profluthrin, pyrethrin (pyrethrum), resmethrin, RU 15525, silafluofen, tefluthrin, tetramethrin [(1R)-isomers)], tralomethrin, transfluthrin and ZXI 8901; or DDT; or methoxychlor.

(4) Nicotinergic acetylcholine receptor agonists, for example chloronicotinyls, e.g. acetamiprid, clothianidin, dinotefuran, imidacloprid, nitenpyram, thiacloprid, thiamethoxam; or nicotine.

(5) Allosteric acetylcholine receptor modulators (agonists), for example spinosyns, e.g. spinetoram and spino sad.

(6) Chloride channel activators, for example avermectins/milbemycins, e.g. abamectin, emamectin benzoate, lepimectin, and milbemectin.

(7) Juvenile hormone mimics, e.g. hydroprene, kinoprene, methoprene; or fenoxycarb; pyriproxyfen.

(8) Miscellaneous non-specific (multi-site) inhibitors, for example gassing agents, e.g. methyl bromide and other alkyl halides; or chloropicrin; sulfuryl fluoride; borax; tartar emetic.

(9) Selective homopteran feeding blockers, e.g. pymetrozine or flonicamid.

(10) Mite growth inhibitors, e.g. clofentezine, diflovidazin, hexythiazox, etoxazole.

(11) Microbial disruptors of insect midgut membranes, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT crop proteins: Cry1Ab, Cry1Ac, Cry1Fa, Cry2Ab, mCry3A, Cry3Ab, Cry3Bb, Cry34/35Ab1.

(12) Inhibitors of mitochondrial ATP synthase, for example diafenthiuron; or organotin miticides, e.g. azocyclotin, cyhexatin, and fenbutatin oxide; or propargite; tetradifon.

(13) Uncouplers of oxidative phoshorylation via disruption of the proton gradient, for example chlorfenapyr, and DNOC.

(14) Nicotinic acetylcholine receptor channel blockers, for example bensultap, cartap hydrochloride, thiocyclam, and thiosultap-sodium.

(15) Inhibitors of chitin biosynthesis, type 0, for example benzoylureas, e.g. bistrifluron, chlorfluazuron, diflubenzuron, flucycloxuron, flufenoxuron, hexaflumuron, lufenuron, novaluron, noviflumuron, penfluron, teflubenzuron, and triflumuron.

(16) Inhibitors of chitin biosynthesis, type 1, for example buprofezin.

(17) Moulting disruptors, for example cyromazine.

(18) Ecdysone receptor agonists/disruptors, for example diacylhydrazines, e.g. chromafenozide, halofenozide, methoxyfenozide, and tebufenozide.

(19) Octopamine receptor agonists, for example amitraz.

(20) Mitochondrial complex III electron transport inhibitors, for example hydramethylnon; acequinocyl or fluacrypyrim.

(21) Mitochondrial complex I electron transport inhibitors, for example METI acaricides, e.g. fenazaquin, fenpyroximate, pyrimidifen, pyridaben, tebufenpyrad, tolfenpyrad or rotenone. (Denis).

(22) Voltage-dependent sodium channel blockers, e.g. indoxacarb; metaflumizone.

(23) Inhibitors of acetyl CoA carboxylase, for example tetronic acid derivatives, e.g. spirodiclofen and spiromesifen; or tetramic acid derivatives, e.g. spirotetramat.

(24) Mitochondrial complex IV electron inhibitors, for example phosphines, e.g. aluminium phosphide, calcium phosphide, phosphine, and zinc phosphide or cyanide.

(25) Mitochondrial complex II electron transport inhibitors, for example cyenopyrafen.

(28) Ryanodine receptor modulators, for example diamides, e.g. flubendiamide, chlorantraniliprole (Rynaxypyr), cyantraniliprole (Cyazypyr), 3-bromo -N-{2-bromo-4-chloro-6-[(1-cyclopropylethyl) carbamoyl]phenyl}-1-(3-chloropyridin-2-yl)-1H-pyrazole-5-carboxamide (known from WO 2005/077934) and methyl 2-[3,5-dibromo-2-({[3-bromo-1-(3-chloropyridin-2-yl)-1H-pyrazol-5-yl]carbonyl}amino)benzoyl]-1,2-dimethylhydrazinecarboxylate (known from WO 2007/043677).

(29) Further active ingredients with unknown or uncertain mode of action, for example azadirachtin, amidoflumet, benzoximate, bifenazate, chinomethionat, cryolite, cyflumetofen, dicofol, fluensulfone (5-chloro-2-[(3,4,4-trifluorobut-3-en-1-yl)sulfonyl]-1,3-thiazole), flufenerim, pyridalyl, and pyrifluquinazon; furthermore products based on Bacillus firmus (I-1582, BioNeem, Votivo) or one of the following known active compounds: 4-{[(6-bromopyrid-3-yl)methyl](2-fluoroethyl)amino} furan-2(5H)-on (known from WO 2007/115644), 4-{[(6-fluoropyrid-3-yl)methyl](2,2-difluoroethyl)amino} furan-2 (5H)-on (known from WO 2007/115644), 4-{[(2-chloro-1,3-thiazol-5-yl)methyl](2-fluoroethyl)amino} furan-2(5H)-on (known from WO 2007/115644), 4-{[(6-chloropyrid-3-yl)methyl](2-fluoroethyl)amino} furan-2(5H)-on (known from WO 2007/115644), 4-{[(6-chloropyrid-3-yl)methyl](2,2-difluoroethyl)amino} furan-2(5H)-on (known from WO 2007/115644), 4-{[(6-chloro-5-fluoropyrid-3-yl)methyl](methyl)amino} furan-2(5H)-on (known from WO 2007/115643), 4-{[(5,6-dichloropyrid-3-yl)methyl](2-fluoroethyl)amino} furan-2(5H)-on (known from WO 2007/115646), 4-{[(6-chloro-5-fluoropyrid-3-yl)methyl](cyclopropyl)amino} furan-2(5H)-on (known from WO 2007/115643), 4-{[(6-chloropyrid-3-yl)methyl](cyclopropyl)amino} furan-2(5H)-on (known from EP-A-0 539 588), [1-(6-chloropyridin-3-yl)ethyl](methyl)oxido-λ⁴-sulfanylidencyanamide (known from WO 2007/149134) and its diastereomers {[(1R)-1-(6-chloropyridin-3-yl)ethyl](methyl)oxido-lambda⁴-sulfanyliden}cyanamide (A) and {[(1.5)-1-(6-chloropyridin-3-yl)ethyl](methyl)oxido-lambda⁴-sulfanyliden}cyanamide (B) (also known from WO 2007/149134) as well as sulfoxaflor (also known from WO 2007/149134) and its diastereomers {(R)-1-[6-(trifluoromethyl)pyridin-3-yl]ethyl}-(R)-(methyl)oxido-lambda4-sulfanylidenecyanamide (A¹) and {(S)-1-[6-(trifluoromethyl) pyridin-3-yl]ethyl}-(S)-(methyl)oxido-lambda⁴-sulfanylidenecyanamide (A²), described as diastereomeric group A (known from WO 2010/074747, WO 2010/074751), {(R)-1-[6-(trifluoromethyl)pyridin-3-yl]ethyl}-(S)-(methyl)oxido-lambda⁴-sulfanylidene-cyanamide (B¹) and {(S)-1-[6-(trifluoromethyl)pyridin-3-yl]ethyl}-(R)-(methyl)oxido-lambda⁴-sulfanylidenecyanamide (B²), described as diastereomeric group B (also known from WO 2010/074747, WO 2010/074751). 11-(4-chloro-2,6-dimethylphenyl)-12-hydroxy-1,4-dioxa-9-azadispiro [4.2.4.2]tetradec-11-en-10-one (known from WO 2006/089633), 3-(4′-fluoro-2,4-dimethylbiphenyl-3-yl)-4-hydroxy-8-oxa-1-azaspiro[4.5]dec-3-en-2-one (known from WO 2008/067911), 1-[2-fluoro-4-methyl-5-[(2,2,2-trifluoroethyl)sulfinyl]phenyl]-3-(trifluoromethyl)-1H-1,2,4-triazol-5-amine (known from WO 2006/043635) and [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano [4,3-b]chromen-4-yl]methyl cyclopropanecarboxylate (known from WO 2006/129714), 2-cyano-3-(difluoromethoxy)-N,N-dimethylbenzenesulfonamide (known from WO 2006/056433), 2-cyano-3-(difluoromethoxy)-N-methylbenzenesulfonamide (known from WO 2006/100288), 2-cyano-3-(difluoromethoxy)-N-ethylbenzenesulfonamide (known from WO 2005/035486), 4-(difluoromethoxy)-N-ethyl-N-methyl-1,2-benzothiazol-3-amine 1,1-dioxide (known from WO 2007/057407) and N-[1-(2,3-dimethylphenyl)-2-(3,5-dimethylphenyl)ethyl]-4,5-dihydro-1,3-thiazol-2-amine (known from WO 2008/104503).

The before mentioned active ingredients specified by their “common name” are known and described, for example, in the Pesticide Manual (“The Pesticide Manual”, 14^{th} Ed., British Crop Protection Council 2006) or can be searched in the interne (e.g. http://www.alanwood.net/pesticides).

It is understood that—even if not expressly mentioned the naming of the compound 4-{[(6-chloropyrid-3-yl)methyl](methyl)amino} furan-2(5H)-one in the context of the invention only refers to its crystalline modification I as defined in WO 2008/040445.

Moreover, the term “controlling” as used herein means that the combinations, mixtures or compositions according to the invention are effective in reducing the incidence of the respective agricultural pest. More specifically, “controlling”, as used herein, means that the active compound is effective in killing the respective agricultural pests, inhibiting its growth, or inhibiting its proliferation.

From the insecticides acaricides or nematicides of group (A), the following compounds are preferred: Spirotetramat, Thiacloprid, Imidacloprid, Clothianidin, Thiamethoxam, Acetamiprid, Abamectin, Bacillus firmus I-1582, Deltamethrin, L-Cyhalothrin, B-Cyfluthrin, Tefluthrin, Transfluthrin, Fipronil, Chlorantraniliprole, Cyantraniliprole, Flubendiamide, Spinosad, Spinetoram, Sulfoxaflor, and Flonicamid.

The invention is further directed to the combination, mixture or composition as defined herein, wherein the weight or molar ratio of the crystalline modification I of 4-{[(6-chloropyrid-3-yl)methyl](methyl)amino} furan-2(5H)-one and the compound of group (A) lies in the range from 200:1 to 1:200, preferred in the range from about 50:1 to about 1:50, or in the range from about 20:1 to 1:20, or in the range from about 10:1 to about 1:10, or in the range from about 5:1 to about 1:5, more preferred in the range from about 2:1 to about 1:2, or from about 1:4 to about 1:2.

Moreover, the invention is directed to the combination, mixture or composition as defined herein, wherein the combination, mixture or composition contains at least one additional agrochemically active ingredient, preferably an additional insecticide, acaricides or nematicide and/or a fungicide. It is preferred to use such a combination, mixture or composition according to the invention for treating seed to achieve the protection of the seed and/or shoots and foliage of a plant emerging from the seed. If a fungicide, preferably of group (B) is present, such combinations, mixtures or compositions can additionally be used to curatively or preventively control the phytopathogenic fungi of plants or crops.

The invention also relates to the use of the combination, mixture or composition as defined herein for the treatment of plant propagation material (seed), and to a method for protecting plants, plant parts, plant propagation material (seed) and/or shoots and foliage of a plant grown from plant propagation material from damage by pythopathogenic fungi, insects, acari, and/or nematodes, (agricultural pests). The invention certainly also encompasses seed which have been treated with the combination, mixture or composition as defined herein.

The biological activity of either the crystalline modification I of 4-{[(6-chloropyrid-3-yl)methyl](methyl)amino} furan-2(5H)-one or a compound of group (A) is in general good. However, especially at low application rates, and on certain pests they do not always satisfy the needs of agricultural practice where an economically efficient and ecologically safe pest control is still being sought.

The objectives of the invention are to meet one or more of the demands mentioned above, such as the reduction of the dosage rate, a broadening of the spectrum of pests that can be controlled, including resistant pests, or the specific demands for the applicability on plant propagation material (e.g. seed).

As already mentioned, the inventors found that binary mixtures comprising 4-{[(6-chloropyrid-3-yl)methyl](methyl)amino} furan-2(5H)-one and one compound selected from the group (A) show unexpectedly high activities in the control of insects, acari, or nematodes. These activities are synergistic, which means that the observed activity of the composition is higher than the sum of the activities of the single components.

The synergistic action of the combination, mixture or composition according to the invention which comprises the crystalline modification I of 4-{[(6-chloropyrid-3-yl)methyl](methyl)amino} furan-2(5H)-one and at least one compound of group (A) extends the insecticidal, nematicidal or acaricidal range of action of 4-{[(6-chloropyrid-3-yl)methyl](methyl)amino} furan-2(5H)-one and of compounds of group (A) primarily by reducing the dosage rate and by broadening of the spectrum of agricultural pests that can be controlled. Thus, the combinations according to the invention still achieve a high degree of pest control even in cases where the individual compounds of the combination, mixture or composition according to the invention do not show sufficient activity at the low application rates employed.

In addition to the synergistic effect described above, the combinations, mixtures or compositions according to the invention may show further surprising advantages including increased safety in use; reduced phytotoxicity and thus better tolerance by plants; the control of agrocultural pests in their different development stages; better behaviour during formulation of the insecticidal compounds, for example during grinding or mixing, during their storage or during their use; a very advantageous biocidal spectrum, even at low rates of concentration, while being well tolerated by warm-blooded organisms, fish and plants; and achievement of an additional effect, e.g. an algicidal, anthelmintic, avicidal, bactericidal, molluscicidal, nematicidal, plant-activating, rodenticidal or virucidal action. Further, the combinations according to the invention surprisingly display increased positive growth and health effects on plants and plant parts treated.

The combinations, mixtures or compositions according to the invention can further contain at least one additional insecticide, acaricide or nematicide, preferably selected from the insecticides, acaricides or nematicides as given in group (A).

As mentioned before, the combinations, mixtures or compositions according to the invention can further contain at least one additional insecticide, acaricide or nematicide, preferably selected from the insecticides, acaricides or nematicides of group (A) and/or a fungicide selected from the compounds of group (B). Such combinations, mixtures or compositions exhibit further synergistic effects and are particularly preferred for protecting seeds and plants emerging from the seeds

The fungicides contained in group (B) are:

(1) Inhibitors of the ergosterol biosynthesis, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifine, nuarimol, oxpoconazole, paclobutrazol, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methyl-imidoformamide, N-ethyl-N-methyl-N′-{2-methyl-5-(trifluoromethyl)-4-[3-(trimethylsilyl)prop-oxy]phenyl}imidoformamide and O-[1-(4-methoxyphenoxy)-3,3-dimethylbutan-2-yl] 1H-imidazole-1-carbothioate.

(2) Inhibitors of the respiratory chain at complex I or II, for example bixafen, boscalid, carboxin, diflumetorim, fenfuram, fluopyram, flutolanil, fluxapyroxad, furametpyr, furmecyclox, isopyrazam (mixture of syn-epimeric racemate 1RS,4SR,9RS and anti-epimeric racemate 1RS,4SR,9SR), isopyrazam (anti-epimeric racemate 1RS,4SR,9SR), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamide, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl -1H-pyrazole-4-carboxamide, N-[1-(2,4-dichloro-phenyl)-1-methoxypropan-2-yl]-3-(difluoromethyl)-1-methyl-1H-pyrazole-4-carboxamide and salts thereof.

(3) Inhibitors of the respiratory chain at complex III, for example ametoctradin, amisulbrom, azoxystrobin, cyazofamid, dimoxystrobin, enestroburin, famoxadone, fenamidone, fluoxastrobin, kresoxim-methyl, metominostrobin, orysastrobin, picoxystrobin, pyraclostrobin, pyrametostrobin, pyraoxystrobin, pyribencarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, methyl (2E)-2-{2-[({cyclopropyl[(4-methoxyphenyl)imino]methyl}sulfanyl)methyl]phenyl}-3-methoxyprop-2-enoate, N-(3-ethyl-3,5,5-trimethylcyclohexyl)-3-(formylamino)-2-hydroxybenzamide, 2-{2-[(2,5-dimethylphenoxy)methyl]phenyl}-2-methoxy-N-methylacetamide, (2R)-2-{2-[(2,5-dimethylphenoxy)methyl]phenyl}-2-methoxy-N-methylacetamide and salts thereof.

(4) Inhibitors of the mitosis and cell division, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine, 3-chloro-5-(6-chloropyridin-3-yl)-6-methyl-4-(2,4,6-trifluorophenyl)pyridazine and salts thereof.

(5) Compounds capable to have a multisite action, like for example bordeaux mixture, captafol, captan, chlorothalonil, copper hydroxide, copper naphthenate, copper oxide, copper oxychloride, copper(II)-sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulphur and sulphur preparations including calcium polysulphide, thiram, tolylfluanid, zineb, ziram and salts thereof.

(6) Compounds capable to induce a host defence, like for example acibenzolar-S-methyl, isotianil, probenazole, tiadinil and salts thereof.

(7) Inhibitors of the amino acid and/or protein biosynthesis, for example andoprim, blasticidin-S, cyprodinil, kasugamycin, kasugamycin hydrochloride hydrate, mepanipyrim, pyrimethanil and salts thereof.

(8) Inhibitors of the ATP production, for example fentin acetate, fentin chloride, fentin hydroxide and silthiofam.

(9) Inhibitors of the cell wall synthesis, for example benthiavalicarb, dimethomorph, flumorph, iprovalicarb, mandipropamid, polyoxins, polyoxorim, validamycin A and valifenalate.

(10) Inhibitors of the lipid and membrane synthesis, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.

(11) Inhibitors of the melanine biosynthesis, for example carpropamid, diclocymet, fenoxanil, phthalide, pyroquilon and tricyclazole.

(12) Inhibitors of the nucleic acid synthesis, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.

(13) Inhibitors of the signal transduction, for example chlozolinate, fenpiclonil, fludioxonil, iprodione, procymidone, quinoxyfen and vinclozolin.

(14) Compounds capable to act as an uncoupler, like for example binapacryl, dinocap, ferimzone, fluazinam and meptyldinocap.

(15) Further compounds, like for example benthiazole, bethoxazin, capsimycin, carvone, chinomethionat, chlazafenone, cufraneb, cyflufenamid, cymoxanil, cyprosulfamide, dazomet, debacarb, dichlorophen, diclomezine, difenzoquat, difenzoquat methylsulphate, diphenylamine, ecomate, fenpyrazamine, flumetover, fluoroimide, flusulfamide, flutianil, fosetyl-aluminium, fosetyl-calcium, fosetyl-sodium, hexachlorobenzene, irumamycin, methasulfocarb, methyl isothiocyanate, metrafenone, mildiomycin, natamycin, nickel dimethyldithiocarbamate, nitrothal-isopropyl, octhilinone, oxamocarb, oxyfenthiin, pentachlorophenol and salts, phenothrin, phosphorous acid and its salts, propamocarb-fosetylate, propanosine-sodium, proquinazid, pyrrolnitrine, tebufloquin, tecloftalam, tolnifanide, triazoxide, trichlamide, zarilamid, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulfonyl)pyridine, 2,3-dibutyl-6-chlorothieno[2,3-d]pyrimidin-4(3H)-one, 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulfonohydrazide, 5-methyl-6-octyl[1,2,4]triazolo[1,5-a]pyrimidin-7-amine, ethyl (2Z)-3-amino-2-cyano-3-phenylprop-2-enoate, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N-{(Z)-[(cyclopropylmethoxy)imino][6-(difluoromethoxy)-2,3-difluorophenyl]methyl}-2-phenylacetamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl} carbamate, phenazine-1-carboxylic acid, quinolin-8-ol and quinolin-8-ol sulfate (2:1).

(16) Further compounds like for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)biphenyl-2-yl]-1H-pyrazole-4-carboxamide, N-(2′,5′-difluorobiphenyl-2-yl)-1-methyl-3-trifluoromethyl)-1H-pyrazole--carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-2-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)(2,3,4-trimethoxy-6-methylphenyl)methanone and N-[2-(4-{[3-(4-chlorophenyl)prop-2-yn-1-yl]oxy}-3-methoxyphenyl)ethyl]-N-2-(methylsulfonyl)valinamide.

Also here, the before mentioned fungicides specified herein by their “common name” are known and described, for example, in the Pesticide Manual (“The Pesticide Manual”, 14^{th} Ed., British Crop Protection Council 2006) or can be searched in the interne (e.g. http://www.alanwood.net/pesticides).

As mentioned before, it was surprisingly found that the combinations, mixtures or compositions according to the invention are particularly suited for the protection of seed and/or shoots and foliage of a plant grown from the seed from damage by insects, acari, nematodes and/or phytopathogenic fungi. The combinations according to the invention show negligible phytotoxicity when applied to the plant propagation material, compatibility with soil conditions (e.g. concerning binding of the compound to the soil), systemic activity in the plant, no negative impact on germination, and efficacy during appropriate pest life cycle.

Throughout this document the expression “combination” or “mixture” stands for the various combinations or mixtures of the crystalline modification I of 4-{[(6-chloropyrid-3-yl)methyl](methyl)amino} furan-2(5H)-one and compounds of group (A), and optionally a further compound of group (B), for example in a single “ready-mix” form, in a combined spray mixture composed from separate formulations of the single active ingredient components, such as a “tank-mix”, or in mixes that are coated on a seed either by direct mixing prior to seed treatment or by separate applications of the components onto the seed, whereby the mixing occurs in the seed or the plant grown from that seed.

The order of applying the crystalline modification I of 4-{[(6-chloropyrid-3-yl)methyl](methyl)amino} furan-2(5H)-one and the compounds of group (A) and, if applicable of group (B) is in general not essential for working the present invention.

The term “plant propagation material” is understood to denote generative parts of the plant, such as seeds, which can be used for the multiplication of the latter, and vegetative material, such as cuttings or tubers, for example potatoes. There may be mentioned for example seed (in the strict sense), roots, fruits, tubers, bulbs, rhizomes and parts of plants. Germinated plants and young plants, which are to be transplanted after germination or after emergence from the soil, may also be mentioned. These young plants may be protected before transplantation by a total or partial treatment by immersion. Preferably “plant propagation material” is understood to denote seeds.

The combinations, mixtures and compositions according to the invention can be used for controlling pests which occur in the agriculture, forestry, or for protecting storage goods and materials by controlling unwanted pests, and they may be used in the hygiene sector for controlling unwanted pests.

The weight ratios of the active ingredients of the combinations, mixtures or compositions as well as the application rate depend on the kind and occurrence of the pests and fungi. Optimal weight ratios and application rates can be determined by test series for each use. In general, the weight ratio of the crystalline modification I of the compound 4-{[(6-chloropyrid-3-yl)methyl](methyl)amino} furan-2(5H)-one to the sum of the compounds of group (A) and, if applicable, of group (B) is in the range from about 1000:1 to about 1:100, preferred in the range of about 625:1 to about 1:100, more preferred in the range of about 125:1 to about 1:50, and most preferred in the range of about 25:1 to 1:5.

Additionally, further optimal weight ratios and application rates can be determined by test series for each use. In general, the weight ratio of the compound 4-{[(6-chloropyrid-3-yl)methyl](methyl)amino} furan-2(5H)-one to the sum of the compounds of group (A) and, if applicable, of group (B) is in the range from about 100:1 to 1:1000, preferred in the range from about 100:1 to about 1:625, more preferred in the range of about 50:1 to about 1:125, and most preferred in the range from about 5:1 to about 1:25.

Further preferred mixing ratios for 4-{[(6-chloropyrid-3-yl)methyl](methyl)amino} furan-2(5H)-one to the sum of compounds from group (A) and, if applicable, of group (B) are: In the range from about 200:1 to about 1:200, particularly from about 50:1 to about 1:50, or in the range from about 20:1 to 1:20, or in the range from about 10:1 to about 1:10, or the range from about 5:1 to about 1:5. Particularly preferred mixing ratios are the range from about 2:1 to about 1:2, or from about 1:4 to about 1:2. Examples of the preferred ratios are: 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750.

According to the invention all plants and plant parts can be treated. By plants is meant all plants and plant populations such as desirable and undesirable wild plants or cultigens (including naturally occurring cultigens). Cultigens can be plants obtained by conventional propagation and optimisation methods or by bioengineering and genetic engineering methods or by combinations of these methods, including transgenic plants and including plant varieties protectable or not protectable by plant varieties protective rights. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

The especially advantageous action of the combinations, mixtures and compositions according to the invention are emphasized in respect of the application for cereals, for example, wheat, oats, barley, spelt, triticale, and rye, but also maize, millet, rice, sugar cane, soy, sunflower, potatoes, cotton, rape, canola, tobacco, sugar beet, fodder beet, asparagus, hops as well as fruit plants (including rosaceous fruit, for example apples and pears, stone-fruits, for example peaches, nectarines, cherries, plums and apricots, citrus fruit, for example, oranges, grapefruit, limes, lemons, kumquats, mandarins and satsumas, nuts, for example pistachios, almonds, walnuts and pecan nuts, tropical fruits, for example, mango, papaya, pineapple, dates and bananas, and grapes) and vegetables (including leaf vegetables, for example endives, lambs lettuce, fennel, globe and loose-leaf salad, chard, spinach and chicory, brassicas, for example, cauliflower, broccoli, Chinese cabbage, kale (winter kale or curly kale), kohlrabi, brussel sprouts, red cabbage, white cabbage and savoy, fruiting vegetables, for example, aubergines, cucumbers, paprika, marrow, tomatoes, courgettes and sweetcorn, root vegetables, for example celeriac, turnip, carrots, swedes, radishes, horse radish, beetroot, salsify, celery, pulses, for example, peas and beans, and bulb vegetables, for example leeks and onions).

In an embodiment of the invention, the invention is directed to the use of the combination, mixture or composition according to the invention for controlling pests which occur in rice, cotton, tea, vegetables, sugar cane, soybean, potato, top fruits, corn, cereals, vine, ornamentals, rangeland and pastures, oil seed rape, and canola. Thus the invention also includes the use of the combination, mixture or composition according to the invention on rice, cotton, tea, vegetables, sugar cane, soybean, potato, top fruits, corn, cereals, vine, ornamentals, rangeland and pastures, oil seed rape, and canola. The invention also includes a method for controlling pests which occure in rice, cotton, tea, vegetables, sugar cane, soybean, potato, top fruits, corn, cereals, vine, ornamentals, rangeland and pastures, oil seed rape, and canola comprising treating the plant or plant parts (including seed and plants emerging from the seeds) with the combination, mixture or composition according to the invention. Preferably in the mixing ratios as defined herein.

Particularly preferred plants to work the invention on are corn, cereals, soybean, cotton, vegetables, oil seed rape, rice and canola. Very particularly preferred plants to work the invention on are corn, cereals, cotton, oil seed rape and rice.

The fact that the active compound combinations are well tolerated by plants at the concentrations required for controlling plant diseases permits a treatment of entire plants (above-ground parts of plants and roots), of propagation stock and seed, and of the soil. The active compound combinations according to the invention can be used for foliar application or else as seed dressings.

A large part of the damage to crop plants which is caused by insects occurs as early as when the seed is attacked during storage and after the seed is introduced into the soil, during and immediately after germination of the plants. This phase is particularly critical since the roots and shoots of the growing plant are particularly sensitive and even minor damage can lead to the death of the whole plant. Protecting the seed and the germinating plant by the use of suitable compositions is therefore of particularly great interest.

The control of agrocultural pests which damage plants post-emergence is carried out primarily by treating the soil and the above-ground parts of plants with crop protection agents, here the combination, mixture or composition according to the invention. Owing to the concerns regarding a possible impact of crop protection agents on the environment and the health of man and animals, there are efforts to reduce the amount of active compounds applied.

The control of insects, acari or nematodes and phytopathogenic fungi, by treating the seeds of plants has been known for a long time and is subject-matter of continuous improvements. However, the treatment of seed frequently entails a series of problems which cannot always be solved in a satisfactory manner. Thus, it is desirable to develop methods for protecting the seed and the germinating plant which dispense with the additional application of crop protection agents, here combinations, mixtures or compositions, after sowing or after the emergence of the plants or where additional applications are at least reduced. It is furthermore desirable to optimize the amount of active compound employed in such a way as to provide maximum protection for the seed and the germinating plant from attack by phytopathogenic fungi, but without damaging the plant itself by the active compound employed. In particular, methods for the treatment of seed should also take into consideration the intrinsic fungicidal properties of transgenic plants in order to achieve optimum protection of the seed and the germinating plant with a minimum of crop protection agents, i.e. amount of agrochemically active ingredients in the combination, mixture or composition according to the invention, being employed.

The present invention therefore in particular also relates to a method for the protection of seed and germinating plants and/or the plant emerging from the seed from attack by insects, acari or nematodes and phytopathogenic fungi, by treating the seed with a combination, mixture or composition according to the invention.

The invention likewise relates to the use of the combinations, mixtures or compositions according to the invention for the treatment of seed for protecting the seed and the germinating plant and/or the plant emerging from the seed from insects, acari or nematodes and phytopathogenic fungi.

Furthermore, the invention relates to seed which has been treated with a combination, mixture or composition according to the invention so as to afford protection from insects, acari or nematodes and phytopathogenic fungi.

The active compound combinations, mixtures or compositions, having good plant compatibility and favourable homeotherm toxicity, are suitable for controlling animal pests (insects, arachnids, helminths, nematodes and mollusks) encountered in agriculture, in forests, in the protection of stored products and materials and in the hygiene sector. They are preferably used as crop protection compositions for foliar-, soil-, and seed treatment.

The active compound combinations, mixtures or compositions according to the invention, in combination with good plant tolerance and favourable toxicity to warm-blooded animals and being tolerated well by the environment, are suitable for protecting plants and plant organs, for increasing harvest yields, for improving the quality of the harvested material and for controlling animal pests, in particular insects, arachnids, helminths, nematodes and molluscs, which are encountered in agriculture, in horticulture, in animal husbandry, in forests, in gardens and leisure facilities, in the protection of stored products and of materials, and in the hygiene sector. They can be preferably employed as plant protection agents. They are active against normally sensitive and resistant species and against all or some stages of development. The abovementioned apests include:

Order: Arthropoda:

From the class of the Arachnida, for example Acarus spp., Aceria sheldoni, Aculops spp., Aculus spp., Amblyomma spp., Amphitetranychus viennensis, Argas spp., Boophilus spp., Brevipalpus spp., Bryobia praetiosa, Centruroides spp., Chorioptes spp., Dermanyssus gallinae, Dermatophagoides pteronyssius, Dermatophagoides farinae, Dermacentor spp., Eotetranychus spp., Epitrimerus pyri, Eutetranychus spp., Eriophyes spp., Halotydeus destructor, Hemitarsonemus spp., Hyalomma spp., Ixodes spp., Latrodectus spp., Loxosceles spp., Metatetranychus spp., Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vaejovis spp., Vasates lycopersici.

From the order of the Anoplura (Phthiraptera), for example, Damalinia spp., Haematopinus spp., Linognathus spp., Pediculus spp., Ptirus pubis, Trichodectes spp.

From the order of the Chilopoda, for example, Geophilus spp., Scutigera spp.

From the order of the Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptorhynchus lapathi, Cylindrocopturus spp., Dermestes spp., Diabrotica spp., Dichocrocis spp., Diloboderus spp., Epilachna spp., Epitrix spp., Faustinus spp., Gibbium psylloides, Hellula undalis, Heteronychus arator, Heteronyx spp., Hylamorpha elegans, Hylotrupes bajulus, Hypera postica, Hypothenemus spp., Lachnosterna consanguinea, Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllotreta spp., Popillia japonica, Premnotrypes spp., Prostephanus truncatus, Psylliodes spp., Ptinus spp., Rhizobius ventralis, Rhizopertha dominica, Sitophilus spp., Sphenophorus spp., Stegobium paniceum, Sternechus spp., Symphyletes spp., Tanymecus spp., Tenebrio molitor, Tribolium spp., Trogo-derma spp., Tychius spp., Xylotrechus spp., Zabrus spp.

From the order of the Collembola, for example, Onychiurus armatus.

From the order of the Diplopoda, for example, Blaniulus guttulatus.

From the order of the Diptera, for example, Aedes spp., Agromyza spp., Anastrepha spp., Anopheles spp., Asphondylia spp., Bactrocera spp., Bibio hortulanus, Calliphora erythrocephala, Ceratitis capitata, Chironomus spp., Chrysomyia spp., Chrysops spp., Cochliomyia spp., Contarinia spp., Cordylobia anthropophaga, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hylemyia spp., Hyppobosca spp., Hypoderma spp., Liriomyza spp., Lucilia spp., Lutzomia spp., Mansonia spp., Musca spp., Nezara spp., Oestrus spp., Oscinella frit, Pegomyia spp., Phlebotomus spp., Phorbia spp., Phormia spp., Prodiplosis spp., Psila rosae, Rhagoletis spp., Sarcophaga spp., Simulium spp, Stomoxys spp., Tabanus spp., Tannia spp., Tetanops spp., Tipula spp.

From the order of the Heteroptera, for example, Anasa tristis, Antestiopsis spp., Boisea spp., Blissus spp., Calocoris spp., Campylomma livida, Cavelerius spp., Cimex spp., Cimex lectularius, Cimex hemipterus, Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.

From the order of the Homoptera, for example, Acyrthosipon spp., Acrogonia spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Drosicha spp., Dysaphis spp., Dysmicoccus spp., Empoasca spp., Eriosoma spp., Erythroneura spp., Euscelis bilobatus, Ferrisia spp., Geococcus coffeae, Hieroglyphus spp., Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes spp., Trioza spp., Typhlocyba spp., Unaspis spp., Viteus vitifolii, Zygina spp.

From the order of the Hymenoptera, for example, Acromyrmex spp., Athalia spp., Atta spp., Diprion spp., Hoplocampa spp., Lasius spp., Monomorium pharaonis, Solenopsis invicta, Tapinoma spp., Vespa spp.

From the order of the Isopoda, for example, Armadillidium vulgare, Oniscus asellus, Porcellio scaber.

From the order of the Isoptera, for example, Coptotermes spp., Cornitermes cumulans, Cryptotermes spp., Incisitermes spp., Microtermes obesi, Odontotermes spp., Reticulitermes spp.

From the order of the Lepidoptera, for example, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., Choristoneura spp., Clysia ambiguella, Cnaphalocerus spp., Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamestra brassicae, Mocis spp., Mythimna separata, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudoplusia includens, Pyrausta nubilalis, Rachiplusia nu, Schoenobius spp., Scirpophaga spp., Scotia segetum, Sesamia spp., Sparganothis spp., Spodoptera spp., Stathmopoda spp., Stomopteryx subsecivella, Synanthedon spp., Tecia solanivora, Thermesia gemmatalis, Tinea pellionella, Tineola bisselliella, Tortrix spp., Trichophaga tapetzella, Trichoplusia spp., Tuta absoluta, Virachola spp.

From the order of the Orthoptera, for example, Acheta domesticus, Blatta orientalis, Blattella germanica, Dichroplus spp., Gryllotalpa spp., Leucophaea maderae, Locusta spp., Melanoplus spp., Periplaneta spp., Pulex irritans, Schistocerca gregaria, Supella longipalpa.

From the order of the Siphonaptera, for example, Ceratophyllus spp., Ctenocephalides spp., Tunga penetrans, Xenopsylla cheopis.

From the order of the Symphyla, for example, Scutigerella spp.

From the order of the Thysanoptera, for example, Anaphothrips obscurus, Baliothrips biformis, Drepanothris reuteri, Enneothrips flavens, Frankliniella spp., Heliothrips spp., Hercinothrips femoralis, Rhipiphorothrips cruentatus, Scirtothrips spp., Taeniothrips cardamoni, Thrips spp.

From the order of the Zygentoma (=Thysanura), for example, Lepisma saccharina, Thermobia domestica.

Order: Mollusca: From the class of the Bivalvia, for example, Dreissena spp.

From the class of the Gastropoda, for example, Anon spp., Biomphalaria spp., Bulinus spp., Deroceras spp., Galba spp., Lymnaea spp., Oncomelania spp., Pomacea spp., Succinea spp.

Order: Plathelminthes, Nematodes (animal parasites)

From the class of the Helminths, for example, Ancylostoma duodenale, Ancylostoma ceylanicum, Acylostoma braziliensis, Ancylostoma spp., Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp, Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

Order: Nematodes (plant parasites, phytoparasites)

From the group of the phytoparasitic nematodes, for example, Aphelenchoides spp., Bursaphelenchus spp., Ditylenchus spp., Globodera spp., Heterodera spp., Longidorus spp., Meloidogyne spp., Pratylenchus spp., Radopholus similis, Trichodorus spp., Tylenchulus semipenetrans, Xiphinema spp.

Subphylum: Protozoa: It is furthermore possible to control protozoa, such as Eimeria.

The treatment of plants and plant parts with the active compound combination, mixture or composition is according to the invention carried out directly or by action on their environment, habitat or storage area by means of the normal treatment methods, e.g., by dipping, spraying, evaporation, misting, scattering, coating, and with propagation material, especially seeds, also by single or multiple coating.

Besides the treatment of plants or plant parts other than seeds, the combinations, mixtures or compositions of the invention are particularly suitable for the treatment of seeds. A large part of the damage caused by pests and pathogens on cultigens occurs by infestation of the seed during storage and after sowing the seed in the ground as well as during and immediately after germination of the plants. This phase is especially critical since the roots and shoots of the growing plant are particularly sensitive and even a small amount of damage can lead to withering of the whole plant. There is therefore considerable interest in protecting the seed and the germinating plant by the use of suitable combination, mixture or composition.

The control of pests and pathogens by treatment of the seeds of plants has been known for a considerable time and is the object of continuous improvement. However, there are a number of problems in the treatment of seed that cannot always be satisfactorily solved. Therefore it is worthwhile to develop methods for the protection of seeds and germinating plants which makes the additional application of plant protection agents in a combination, mixture or composition after seeding or after germination of the plants superfluous. It is further worthwhile to optimize the amount of the applied active material such that the seed and the germinating plants are protected against infestation by pests as best as possible without the plants themselves being damaged by the active compound applied. In particular, methods for the treatment seed should also take into account the intrinsic insecticidal and fungicidal properties of transgenic plants in order to achieve optimal protection of the seed and germinating plants with a minimal expenditure of plant protection agents. here the combination, mixture or composition according to the invention.

The present invention relates therefore especially to a method for the protection of seed and germinating plants from infestation with pests and pathogens in that the seed is treated with a combination, mixture or composition according to the invention.

The invention comprises a procedure in which the seed is treated at the same time with crystalline modification I of 4-{[(6-chloropyrid-3-yl)methyl](methyl)amino} furan-2(5H)-one, the component of group (A), and, if applicable of group (B). It further comprises a method in which the seed is treated with crystalline modification I of 4-{[(6-chloropyrid-3-yl)methyl](methyl)amino} furan-2(5H)-one, the component of group (A), and, if applicable of group (B) separately.

The invention also comprises a seed, which has been treated with crystalline modification I of 4-{[(6-chloropyrid-3-yl)methyl](methyl)amino} furan-2(5H)M-one, the component of group (A), and, if applicable of group (B) at the same time or separately. For the latter seed, the active ingredients can be applied in separate layers. These layers can optionally be separated by an additional layer that may or may not contain an active ingredient.

The time interval between the application of different layers of the style compounds is in general not critical.

In addition the invention relates also to the use of the combination, mixture or composition as defined herein for protection of the seed, the germinating plants and/or the plant emerging from the seed from pests via seed treatment. Furthermore the invention relates to seed which was treated with a combination, mixture or composition as defined herein for protection from agricultural pests.

One of the advantages of the invention is because of the special systemic properties of the agrochemically active ingredients of the invention treatment with these actives protects not only the seed itself from pests but also the plants emerging after sprouting. In this way the direct treatment of the culture at the time of sowing or shortly thereafter can be omitted.

It is also be regarded as advantageous that the combinations, mixtures or compositions as defined herein can also be used in particular with transgenic seeds whereby the plants emerging from this seed are capable of the expression of a protein directed against pests and pathogens. By treatment of such seed with the combinations, mixtures or compositions according to the invention certain pests and pathogens can already be controlled by expression of the, for example, insecticidal protein, and it is additionally surprising that a synergistic activity supplementation occurs with the combinations, mixtures or composition according to the invention, which improves still further the effectiveness of the protection from pest and pathogen infestation.

The combinations, mixtures or compositions according to the invention are suitable for the protection of seed of plant varieties of all types as already described which are used in agriculture, in greenhouses, in forestry, in garden construction or in vineyards. In particular, this concerns seed of maize, peanut, canola, rape, poppy, olive, coconut, cacao, soy cotton, beet, (e.g. sugar beet and feed beet), rice, millet, wheat, barley, oats, rye, sunflower, sugar cane or tobacco. The combinations, mixtures or compositions as defined herein are also suitable for the treatment of the seed of fruit plants and vegetables as previously described. Particular importance is attached to the treatment of the seed of maize, soy, cotton, wheat and canola or rape.

As already described, the treatment of transgenic seed with the combinations, mixtures or compositions according to the invention is of particular importance. This concerns the seeds of plants which generally contain at least one heterologous gene that controls the expression of a polypeptide with special insecticidal properties. The heterologous gene in transgenic seed can originate from microorganisms such as Bacillus, Rhizobium, Pseudomonas, Serratia, Trichoderma, Clavibacter, Glomus or Gliocladium. The present invention is particularly suitable for the treatment of transgenic seed that contains at least one heterologous gene that originates from Bacillus sp. and whose gene product exhibits activity against the European corn borer and/or western corn rootworm. Particularly preferred is a heterologous gene that originates from Bacillus thuringiensis.

Within the context of the present invention the agrochemically active ingredients according to the invention are applied to the seed alone or in a suitable formulation. Preferably the seed is handled in a state in which it is so stable, that no damage occurs during treatment. In general treatment of the seed can be carried out at any time between harvest and sowing. Normally seed is used that was separated from the plant and has been freed of spadix, husks, stalks, pods, wool or fruit flesh. Use of seed that was harvested, purified, and dried to moisture content of below 15% w/w. Alternatively, seed treated with water after drying and then dried again can also be used.

In general care must be taken during the treatment of the seed that the amount of the agrochemically active ingredients which are contained in the combinations, mixtures or compositions according to the invention and/or further additive applied to the seed is so chosen that the germination of the seed is not impaired and the emerging plant is not damaged. This is to be noted above all with active compounds which can show phytotoxic effects when applied in certain amounts.

In general care must be taken during the treatment of the seed that the amount of the agent of the invention and/or further additive applied to the seed is so chosen that the germination of the seed is not impaired and the emerging plant is not damaged. This is to be noted above all with active compounds which can show phytotoxic effects when applied in certain amounts.

The agrochemically active ingredients of the combination or the mixture according to the invention can be applied directly, that is without containing additional components and without being diluted. It is normally preferred to apply the agrochemically active ingredients contained in the combination of mixture according to the invention to the seed in the form of a suitable formulation. Suitable formulations, which may constitute a composition according to the invention, and methods for seed treatment are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, U.S. Pat. No. 2003/0176428 A1, WO 2002/080675 A1, WO 2002/028186 A2.

Compositions, which are especially useful for seed treatment, are e.g.:

A Soluble concentrates (SL, LS)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed undiluted. Application to the seeds is carried out before sowing, either directly on the seeds or after having pre-germinated the latter. Preferred are FS formulations.

In the treatment of seed, the application rates of the inventive combination are generally from 0.1 to 10 kg per 100 kg of seed. The separate or joint application of the crystalline modification I of 4-{[(6-chloropyrid-3-yl)methyl](methyl)amino} furan-2(5H)-one, the component of group (A), and, if applicable of group (B) or of the combinations of the crystalline modification I of 4-{[(6-chloropyrid-3-yl)methyl](methyl)amino} furan-2(5H)-one, the component of group (A), and, if applicable of group (B) is carried out by spraying or dusting the seeds, the seedlings, the plants or the soils before or after sowing of the plants or before or after emergence of the plants.

The invention also relates to the propagation materials of plants, and especially the seed comprising, that is, coated with and/or containing a combination, mixture or composition as defined herein or a composition containing the combination or mixture of two or more active ingredients or a combination of two or more combinations, mixtures or compositions each providing one of the active ingredients. The seed comprises the combinations, mixtures or compositions according to the invention in an amount of from 0.1 g to 10 kg per 100 kg of seed.

The composition according to the invention can be applied “neat”, that is, without any diluting or additional components present. However, the composition is typically applied to the seeds in the form of a agricultural pesticide formulation. This formulation may contain one or more other desirable components including but not limited to liquid diluents, binders to serve as a matrix for the pesticide, fillers for protecting the seeds during stress conditions, and plasticizers to improve flexibility, adhesion and/or spreadability of the coating. In addition, for oily pesticide formulations containing little or no filler, it may be desirable to add to the formulation drying agents such as calcium carbonate, kaolin or bentonite clay, perlite, diatomaceous earth or any other adsorbent material. Use of such components in seed treatments is known in the art. See, e.g. U.S. Pat. No. 5,876,739 B. The skilled person can readily select desirable components to use in the pesticide formulation depending on the seed type to be treated and the particular pesticide that is selected. In addition, readily available commercial formulations of known pesticides may be used, as demonstrated in the examples below.

The seeds may also be treated with one or more of the following ingredients: other pesticides, including compounds which act only below the ground; fungicides, such as captan, thiram, metalxyl, fludioxonil , oxadixyl, and isomers of each of those materials, and the like; herbicides, including compounds selected from acetamides, triazines, dinitroanilines, glycerol ethers, pyridazinones, uracils, phenoxys, ureas, and benzoic acids; herbicidal safeners such as benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives; fertilizers; and biocontrol agents such as naturally-occurring or recombinant bacteria and fungi from the genera Rhizobium, Bacillus, Pseudomonas, Serratia, Trichoderma, Glomus, Gliocladium and mycorrhizal fungi. These ingredients may be added as a separate layer on the seed or alternatively may be added as part of the pesticide composition. Preferably, the amount of the novel composition or other ingredients used in the seed treatment should not inhibit generation of the seed, or cause phytotoxic damage to the seed.

Preferably, the amount of the novel composition or other ingredients used in the seed treatment should not inhibit generation of the seed, or cause phytotoxic damage to the seed.

The composition of the present invention can be in the form of suspension concentrates, oil-based suspension concentrates and, for example, water-dispersible granules and also similar formulations for treating seed. By virtue of the stability of the crystalline modification I of 4-{[(6-chloropyrid-3-yl)methyl](methyl)amino} furan-2(5H)-one, it bestows onto these formulations the desired long-lasting storage stability. Using the crystalline modification I of 4-{[(6-chloropyrid-3-yl)methyl](methyl)amino} furan-2(5H)-one together with the component of group (A), and, if applicable of group (B) it is thus possible to prepare in a defined and targeted manner stable solid preparations.

As mentioned above, other conventional inactive or inert ingredients can be incorporated into the formulation. Such inert ingredients include but are not limited to: Conventional sticking agents, dispersing agents such as methylcellulose (Methocel A15LV or Methocel A15C, for example, serve as combined dispersant/sticking agents for use in seed treatments), polyvinyl alcohol (e.g., Elvanol 51-05), lecithin (e.g., Yelkinol P), polymeric dispersants (e.g., polyvinylpyrrolidone/vinyl acetate PVP/VA S-630), thickeners (e.g., clay thickeners such as Van Gel B to improve viscosity and reduce settling of particle suspensions), emulsion stabilizers, surfactants, antifreeze compounds (e.g., urea), dyes, colorants, and the like. Further inert ingredients useful in the present invention can be found in McCutcheon's, vol. 1, “Emulsifiers and Detergents” MC Publishing Company, Glen Rock, N.J., U.S.A., 1996. Additional inert ingredients useful in the present invention can be found in McCutcheon's, vol.2, “FunctionalMaterials,” MC Publishing Company, Glen Rock, N.J., U.S.A., 1996.

The active ingredients, combinations, mixtures or compositions of the present invention can be applied to seeds by any standard seed treatment methodology, including but not limited to mixing in a container (e.g., a bottle or bag), mechanical application, tumbling, spraying, and immersion. Any conventional active or inert material can be used for contacting seeds with pesticides according to the present invention, such as conventional film-coating materials including but not limited to water-based film coating materials such as Sepiret (Seppic, Inc., Fairfield, N.J.) and Opacoat (Berwind Pharm. Services, Westpoint, Pa.).

Seed coating: The combination, mixture or composition according to the invention can be applied to a seed as a component of a seed coating. Seed coating methods and compositions that are known in the art are useful when they are modified by the addition of one of the embodiments of the combination, mixture or composition according to the invention. Such coating methods and apparatus for their application are disclosed in, for example, U.S. Pat. Nos. 5,918,413, 5,891,246, 5,554,445, 5,389,399, 5,107,787, 5,080,925, 4,759,945 and 4,465,017. Seed coating compositions are disclosed, for example, in U.S. Pat. Nos. 5,939,356, 5,882,713, 5,876,739, 5,849,320, 5,834,447, 5,791,084, 5,661,103, 5,622,003, 5,580,544, 5,328,942, 5,300,127, 4,735,015, 4,634,587, 4,383,391, 4,372,080, 4,339,456, 4,272,417 and 4,245,432, among others. Useful seed coatings contain one or more binders and at least one of the combination, mixture or composition according to the invention.

Useful seed coatings contain one or more binders and at least combination, mixture or composition according to the invention.

Binders that are useful in the present invention preferably comprise an adhesive polymer that may be natural or synthetic and is without phytotoxic effect on the seed to be coated. The binder may be selected from polyvinyl acetates; polyvinyl acetate copolymers; polyvinyl alcohols; polyvinyl alcohol copolymers; celluloses, including ethylcelluloses, methylcelluloses, hydroxymethylcelluloses, hydroxypropylcelluloses and carboxymethylcellulose; polyvinylpyroh-dones; polysaccharides, including starch, modified starch, dextrins, maltodextrins, alginate and chitosans; fats; oils; proteins, including gelatin and zeins; gum arabics; shellacs; vinylidene chloride and vinylidene chloride copolymers; calcium lignosulfonates; acrylic copolymers; polyvinylacrylates; polyethylene oxide; acrylamide polymers and copolymers; polyhydroxyethyl acrylate, mefhylacrylamide monomers; and polychloroprene.

It is preferred that the binder be selected so that it can serve as a matrix for combination, mixture or composition according to the invention. While the binders disclosed above may all be useful as a matrix, the specific binder will depend upon the properties of the combination, mixture or composition according to the invention. The term “matrix”, as used herein, means a continuous solid phase of one or more binder compounds throughout which is distributed as a discontinuous phase one or more of the subject combinations, mixtures or compositions according to the invention. Optionally, a filler and/or other components can also be present in the matrix. The term matrix is to be understood to include what may be viewed as a matrix system, a reservoir system or a microencapsulated system. In general, a matrix system consists of a combination, mixture or composition according to the invention and filler uniformly dispersed within a polymer, while a reservoir system consists of a separate phase comprising the combination, mixture or composition according to the invention, that is physically dispersed within a surrounding, rate-limiting, polymeric phase. Microencapsulation includes the coating of small particles or droplets of liquid, but also to dispersions in a solid matrix.

The amount of binder in the coating can vary, but will be in the range of about 0.01 to about 25% of the weight of the seed, more preferably from about 0.05 to about 15%, and even more preferably from about 0.1% to about 10%.

As mentioned above, the matrix can optionally include a filler. The filler can be an absorbent or an inert filler, such as are known in the art, and may include woodflours, clays, activated carbon, sugars, diatomaceous earth, cereal flours, fine-grain inorganic solids, calcium carbonate, and the like. Clays and inorganic solids which may be used include calcium bentonite, kaolin, china clay, talc, perlite, mica, vermiculite, silicas, quartz powder, montmorillonite and mixtures thereof. Sugars which may be useful include dextrin and maltodextrin. Cereal flours include wheat flour, oat flour and barley flour.

The filler is selected so that it will provide a proper microclimate for the seed, for example the filler is used to increase the loading rate of the active ingredients and to adjust the control-release of the active ingredients. The filler can aid in the production or process of coating the seed. The amount of filler can vary, but generally the weight of the filler components will be in the range of about 0.05 to about 75% of the seed weight, more preferably about 0.1 to about 50%, and even more preferably about 0.5% to 15%.

The amount of agrochemically active ingredients that are included in the coating will vary depending upon the type of seed and the type of active ingredients, but the coating will contain an amount of the combination, mixture or composition of agrochemically active ingredients that is pesticidally effective. When insects are the target pest, that amount will be an amount of the combination of insecticides that is insecticidally effective. As used herein, an insecticidally effective amount means that amount of insecticide that will kill insect pests in the larvae or pupal state of growth, or will consistently reduce or retard the amount of damage produced by insect pests. In general, the amount of pesticide in the coating will range from about 0.005 to about 50% of the weight of the seed. A more preferred range for the pesticide is from about 0.01 to about 40%; more preferred is from about 0.05 to about 20%.

The exact amount of the combination, mixture or composition as defined herein that is included in the coating is easily determined by one of skill in the art and will vary depending upon the size of the seed to be coated. The agrochemically active ingredients of the coating must not inhibit germination of the seed and should be efficacious in protecting the seed and/or the plant during that time in the target insect's life cycle in which it causes injury to the seed or plant. In general, the coating will be efficacious for approximately 0 to 120 days after sowing.

The coating is particularly effective in accommodating high pesticidal loads, as can be required to treat typically refractory pests, such as corn root worm, while at the same time preventing unacceptable phytotoxicity due to the increased pesticidal load.

The coating is particularly effective in accommodating high pesticidal loads, as can be required to treat typically refractory pests, such as corn root worm, while at the same time preventing unacceptable phytotoxicity due to the increased pesticidal load.

Optionally, a plasticizer can be used in the coating formulation. Plasticizers are typically used to make the film that is formed by the coating layer more flexible, to improve adhesion and spreadability, and to improve the speed of processing. Improved film flexibility is important to minimize chipping, breakage or flaking during storage, handling or sowing processes. Many plasticizers may be used. However, useful plasticizers include polyethylene glycol, glycerol, butylbenzylphthalate, glycol benzoates and related compounds. The range of plasticizer in the coating layer will be in the range from about 0.1 to about 20% by weight.

When the combination, mixture or composition as defined herein used in the coating is an oily type formulation and little or no filler is present, it may be useful to hasten the drying process by drying the formulation. This optional step may be accomplished by means will known in the art and can include the addition of calcium carbonate, kaolin or bentonite clay, perlite, diatomaceous earth, or any absorbent material that is added preferably concurrently with the pesticidal coating layer to absorb the oil or excess moisture. The amount of calcium carbonate or related compounds necessary to effectively provide a dry coating will be in the range of about 0.5 to about 10% of the weight of the seed.

The coatings formed with the combination, mixture or composition as defined herein are capable of effecting a slow rate of release of the pesticide by diffusion or movement through the matrix to the surrounding medium.

The coating can be applied to almost any crop seed that is described herein, including cereals, vegetables, ornamentals and fruits.

The pesticide formulation may be applied to the seeds using conventional coating techniques and machines, such as fluidized bed techniques, the roller mill method, rotostatic seed treaters, and drum coaters. Other methods, such as spouted beds may also be useful. The seeds may be presized 5 before coating. After coating, the seeds are typically dried and then transferred to a sizing machine for sizing. Such procedures are known in the art.

The pesticide-treated seeds may also be enveloped with a film overcoating to protect the pesticide coating. Such overcoatings are known in the art and may be applied using conventional fluidized bed and drum film coating techniques.

In another embodiment of the present invention, a combination, mixture or composition as defined herein can be introduced onto or into a seed by use of solid matrix priming For example, a quantity of the pesticide can be mixed with a solid matrix material and then the seed can be placed into contact with the solid matrix material for a period to allow the pesticide to be introduced to the seed. The seed can then optionally be separated from the solid matrix material and stored or used, or the mixture of solid matrix material plus seed can be stored or planted directly. Solid matrix materials which are useful in the present invention include polyacrylamide, starch, clay, silica, alumina, soil, sand, polyurea, poly aery late, or any other material capable of absorbing or adsorbing the agrochemically active ingredient for a time and releasing that agrochemically active ingredient into or onto the seed. It is useful to make sure that the pesticide and the solid matrix material are compatible with each other. For example, the solid matrix material should be chosen so that it can release the agrochemically active ingredient at a reasonable rate, for example over a period of minutes, hours, or days.

In yet another embodiment, a powdered combination, mixture or composition as defined herein can be mixed directly with seed. Optionally, a sticking agent can be used to adhere the powder to the seed surface. For example, a quantity of seed can be mixed with a sticking agent and optionally agitated to encourage uniform coating of the seed with the sticking agent. The seed coated with the sticking agent can then be mixed with the powdered pesticide. The mixture can be agitated, for example by tumbling, to encourage contact of the sticking agent with the powdered pesticide, thereby causing the powdered pesticide to stick to the seed.

The present invention also provides a seed that has been treated by the method described above. The treated seeds of the present invention can be used for the propagation of plants in the same manner as conventional treated seed. The treated seeds can be stored, handled, sowed and tilled in the same manner as any other pesticide treated seed. Appropriate safety measures should be taken to limit contact of the treated seed with humans, food or feed materials, water and birds and wild or domestic animals.

The invention will be illustrated by way of the following biological examples.

The expected efficacy of a given combination of two compounds is calculated as follows (see Colby, S .R., “Calculating Synergistic and antagonistic Responses of Herbicide Combinations”, Weeds 15, pp. 20-22, 1967):

If

X is the efficacy expressed in % mortality of the untreated control for test compound A at a concentration of m ppm respectively m g/ha,

Y is the efficacy expressed in % mortality of the untreated control for test compound B at a concentration of n ppm respectively n g/ha,

E is the efficacy expressed in % mortality of the untreated control using the mixture of A and B at m and n ppm respectively m and n g/ha,

then is

$$E = X + Y - \frac{X \cdot Y}{100}$$

If the observed insecticidal efficacy of the combination is higher than the one calculated as “E”, then the combination of the two compounds is more than additive, i.e., there is a synergistic effect.

If not mentioned otherwise, the crystalline modification I of 4-{[(6-chloropyrid-3-yl)methyl](methyl)amino} furan-2(5H)-one has been prepared as a water-dispersible or water-soluble powder in an active ingredient concentration of 70% (wt/wt) involving the following formulation auxiliaries, whereas the amount of auxiliaries sums up to 100 wt. %:

| | |
|---|---|
| 2 wt.-% | Brilliant Ponceau 4RC 70 (1,3-Naphthalenedisulfonic |
| | acid, 7-hydroxy-8-[(4-sulfo-1-naphthalenyl)azo]-, |
| | trisodium salt) |
| 2 wt.-% | Helioechtrubin 4B10 |
| 5 wt.-% | anoinischen Dispergiermittel Baykanol ™ SL |
| | (Kondensationsprodukt von sulfo-niertem Ditolylether |
| | mit Formaldehyd) |
| 4 wt.-% | Synthetic amorphous precipitated silicon dioxide filler |
| | (Ultrasil ™ VN3 Powder) |
| 1.5 wt.-% | Emulgator 1000 TR U (ground) |
| 0.8 wt. % | Baysilone-Defoamer E VM 30 |
| 84.7 wt.-% | Kaolin W |

The auxiliaries were mixed with the appropriate amount of the crystalline modification I of 4-{[(6-chloropyrid-3-yl)methyl](methyl)amino} furan-2(5H)-one. There is no water or solvent added. To enable the dry mixture to stick on the seed, the seed were treated with a minimal amount of water, namely 30 μl for 2 g canola seeds, and 800 μl für 20 g cotton seeds.

### EXAMPLE A

### Aphis gossypii—Test

Cotton seeds were treated with the compounds or mixtures and sown. 10 days after germination the plants were infested with a mixed population of the cotton aphid (Aphis gossypii). After the specified period of time, the mortality in % is determined 100% means that all the aphids have been killed; 0% means that none of the aphids have been killed. In this test, for example, the following combinations according to the invention show a superior level of efficacy compared to the single compounds:

TABLE A

| | Concen- | | |
|---|---|---|---|
| | tration | Mortality | |
| Active ingredient | [mg ai/seed | [in % after 2 days] | |
| Crystalline modification I of 4- | 0.025 | 35 | |
| {[(6-chloropyrid-3- | | | |
| yl)methyl](methyl)amino}furan- | | | |
| 2(5H)-one | | | |
| Spirotetramat | 5 | 0 | |
| | | found* | calculated.** |
| Crystalline modification I of 4- | 0.025 + 5 | 55 | 35 |
| {[(6-chloropyrid-3- | | | |
| yl)methyl](methyl)amino}furan- | | | |
| 2(5H)-one + Spirotetramat | | | |
| (1:200) | | | |
| Crystalline modification I of 4- | 0.01 | 60 | |
| {[(6-chloropyrid-3- | | | |
| yl)methyl](methyl)amino}furan- | | | |
| 2(5H)-one | | | |
| | Concen- | | |
| | tration | Mortality | |
| Active ingredient | [mg ai/seed | [in % after 3 days] | |
| Imidacloprid | 0.01 | 0 | |
| | | found* | calculated.** |
| Crystalline modification I of 4- | 0.01 + 0.01 | 75 | 60 |
| {[(6-chloropyrid-3- | | | |
| yl)methyl](methyl)amino}furan- | | | |
| 2(5H)-one + Imidacloprid | | | |
| (1:1) | | | |

*activity found;
**activity calculated according to the Colby Equation.

### EXAMPLE B

### Myzus persicae—Test

Seeds of Oil seed rape were treated with the compounds or mixtures and sown. Ca. 35 days after germination the plants were infested with a mixed population of the green peach aphid (Myzus persicae).

After the specified period of time, the mortality in % is determined 100% means that all the aphids have been killed; 0% means that none of the aphids have been killed.

In this test, for example, the following combinations according to the invention show a superior level of efficacy compared to the single compounds:

TABLE B

| | Concen- | | |
|---|---|---|---|
| | tration | Mortality | |
| Active ingredient | [mg ai/seed | [in % after 2 days] | |
| Crystalline modification I of | 0.025 | 40 | |
| 4-{[(6-chloropyrid-3- | | | |
| yl)methyl](methyl)amino}furan- | | | |
| 2(5H)-one | | | |
| Acetamiprid | 1 | 0 | |
| | | found* | calculated.** |
| Crystalline modification I of | 0.025 + 1 | 90 | 40 |
| 4-{[(6-chloropyrid-3- | | | |
| yl)methyl](methyl)amino}furan- | | | |
| 2(5H)-one + Acetamiprid | | | |
| (1:40) | | | |

*activity found;
**activity calculated according to the Colby Equation.

1. A composition comprising a crystalline modification I of 4-{[(6-chloropyrid-3-yl)methyl](methyl)amino} furan-2(5H)-one and an insecticide, an acaricide or a nematicide of group (A) selected from the subgroups (1) to (29):
(1) Acetylcholinesterase (AChE) inhibitors: Carbamates, alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC, and xylylcarb; or organophosphates, acephate, azamethiphos, azinphos (-methyl, -ethyl), cadusafos, chlorethoxyfos, chlorfenvinphos, chlorfenvinphos, chlormephos, chlorpyrifos (-methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos (-methyl), profenofos, propetamphos, prothiofos, pyraclofos, pyridaphenthion, quinalphos, sulfotep, tebupirimfos, temephos, terbufos, tetrachlorvinphos, thiometon, triazophos, triclorfon, and vamidothion;
(2) GABA-gated chloride channel antagonists: Organochlorines, chlordane, endosulfan (alpha-); or fiproles (phenylpyrazoles), ethiprole, fipronil, pyrafluprole, and pyriprole;
(3) Sodium channel modulators/voltage-dependent sodium channel blockers: Pyrethroids, acrinathrin, allethrin (d-cis-trans, d-trans), bifenthrin, bioallethrin, bioallethrin S-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans-isomers], deltamethrin, dimefluthrin, empenthrin [(EZ)-(1R)-isomers), esfenvalerate, etofenprox, fenpropathrin, fenvalerate, flucythrinate, flumethrin, fluvalinate (tau-), halfenprox, imiprothrin, metofluthrin, permethrin, phenothrin [(1R)-trans-isomer), prallethrin, profluthrin, pyrethrin (pyrethrum), resmethrin, RU 15525, silafluofen, tefluthrin, tetramethrin [(1R)-isomers)], tralomethrin, transfluthrin and ZXI 8901; or DDT; or methoxychlor;
(4) Nicotinergic acetylcholine receptor agonists: Chloronicotinyls, acetamiprid, clothianidin, dinotefuran, imidacloprid, nitenpyram, thiacloprid, thiamethoxam; or nicotine;
(5) Allosteric acetylcholine receptor modulators (agonists): Spinetoram and spinosad;
(6) Chloride channel activators: Avermectins/milbemycins, abamectin, emamectin benzoate, lepimectin, and milbemectin;
(7) Juvenile hormone mimics, hydroprene, kinoprene, methoprene; or fenoxycarb; pyriproxyfen;
(8) gassing agents, methyl bromide and other alkyl halides; or chloropicrin; sulfuryl fluoride; borax; tartar emetic;
(9) Selective homopteran feeding blockers: Pymetrozine or flonicamid;
(10) Mite growth inhibitors: Lofentezine, diflovidazin, hexythiazox, etoxazole;
(11) Microbial disruptors of insect midgut membranes: Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT crop proteins: CrylAb, CrylAc, CrylFa, Cry2Ab, mCry3A, Cry3Ab, Cry3Bb, Cry34/35Ab1;
(12) Inhibitors of mitochondrial ATP synthase: Diafenthiuron; or organotin miticides, azocyclotin, cyhexatin, and fenbutatin oxide; or propargite; tetradifon;
(13) Uncouplers of oxidative phoshorylation via disruption of the proton gradient: Chlorfenapyr, and DNOC;
(14) Nicotinic acetylcholine receptor channel blockers: Bensultap, cartap hydrochloride, thiocyclam, and thiosultap-sodium;
(15) Inhibitors of chitin biosynthesis, type 0: Benzoylureas, bistrifluron, chlorfluazuron, diflubenzuron, flucycloxuron, flufenoxuron, hexaflumuron, lufenuron, novaluron, noviflumuron, penfluron, teflubenzuron, and triflumuron;
(16) Inhibitors of chitin biosynthesis, type 1: Buprofezin;
(17) Moulting disruptors: Cyromazine;
(18) Ecdysone receptor agonists/disruptors: Diacylhydrazines, chromafenozide, halofenozide, methoxyfenozide, and tebufenozide;
(19) Octopamine receptor agonists: Amitraz;
(20) Mitochondrial complex III electron transport inhibitors: Hydramethylnon; acequinocyl or fluacrypyrim;
(21) Mitochondrial complex I electron transport inhibitors: METI acaricides, fenazaquin, fenpyroximate, pyrimidifen, pyridaben, tebufenpyrad, tolfenpyrad or rotenone.(Derris);
(22) Voltage-dependent sodium channel blockers: Indoxacarb; metaflumizone;
(23) Inhibitors of acetyl CoA carboxylase: Tetronic acid derivatives, spirodiclofen and spiromesifen; or tetramic acid derivatives, spirotetramat;
(24) Mitochondrial complex IV electron inhibitors: Phosphines, aluminium phosphide, calcium phosphide, phosphine, and zinc phosphide or cyanide;
(25) Mitochondrial complex II electron transport inhibitors: Cyenopyrafen;
(28) Ryanodine receptor modulators: diamides, flubendiamide, chlorantraniliprole (Rynaxypyr), cyantraniliprole (Cyazypyr), 3-bromo-N-{2-bromo-4-chloro-6-[(1-cyclopropylethyl) carbamoyl]phenyl}-1-(3-chloropyridin-2-yl)-1H-pyrazole-5-carboxamide and methyl 2-[3,5-dibromo-2-({[3-bromo-1-(3-chloropyridin-2-0-1H-pyrazol-5-yl]carbonyl}amino)benzoyl]-1,2-dimethylhydrazinecarboxylate;
(29) azadirachtin, amidoflumet, benzoximate, bifenazate, chinomethionat, cryolite, cyflumetofen, dicofol, fluensulfone (5-chloro-2-[(3,4,4-trifluorobut-3-en-1-yl)sulfonyl]-1,3-thiazole), flufenerim, pyridalyl, and pyrifluquinazon; furthermore products based on Bacillus firmus (1-1582, BioNeem, Votivo) or one of the following known active compounds: 4-{[(6-bromopyrid-3-yl)methyl](2-fluoroethyl)amino} furan-2(5H )-on, 4-{[(6-fluoropyrid-3-yl)methyl](2,2-difluoroethyl)amino} furan-2(5H)-on, 4-{[(2-chloro-1,3-thiazol-5-yl)methyl](2-fluoroethyl)amino} furan-2(5H)-on, 4-{[(6-chloropyrid-3-yl)methyl](2-fluoroethyl)amino} furan-2(5H)-on, 4-{[(6-chloropyrid-3-yl)methyl](2,2-difluoroethyl)amino} furan-2(5H)-on, 4-{[(6-chloro-5-fluoropyrid-3-yl)methyl](methyl)amino} furan-2(5H)-on, 4-{[(5,6-dichloropyrid-3-yl)methyl](2-fluoroethyl)amino} furan-2(5H)-on, 4-{[(6-chloro-5-fluorpyrid-3-yl)methyl](cyclopropyl)amino} furan-2(5H)-on, 4-{[(6-chloropyrid-3-yl)methyl](cyclopropyl)amino} furan-2 (5H)-on, [1-(6-chloropyridin-3-yl)ethyl](methyl)oxido-λ⁴-sulfanylidencyanamide and its diastereomers {[(1R)-1-(6-chloropyridin-3-yl)ethyl](methyl)oxido-lambda⁴-sulfanyliden}cyanamide (A) and {[(1S)-1-(6-chloropyridin-3-yl)ethyl](methyl)oxido-lambda⁴-sulfanyliden}cyanamide (B) (also known from WO 2007/149134) as well as sulfoxaflor and its diastereomers {(R)-1-[6-(trifluoromethyl)pyridin-3-yl]ethyl}-(R)-(methyl)oxido-lambda⁴-sulfanylidenecyanamide (A¹) and {(S)-1-[6-(trifluoromethyl) pyridin-3-yl]ethyl}-(S)-(methyl)oxido-lambda⁴-sulfanylidenecyanamide (A²), {(R)-1-[6-(trifluoromethyl)pyridin-3-yl]ethyl}-(S)-(methyl)oxido-lambda⁴-sulfanylidene-cyanamide (B¹) and {(S)-1-[6-(trifluoromethyl)pyridin-3-yl]ethyl}-(R)-(methyl)oxido-lambda⁴-sulfanylidenecyanamide (B²), 11-(4-chloro-2,6-dimethylphenyl)-12-hydroxy-1,4-dioxa-9-azadispiro[4.2.4.2]tetradec-11-en-10-one, 3-(4′-fluoro-2,4-dimethylbiphenyl-3-yl)-4-hydroxy-8-oxa-1-azaspiro[4.5]dec-3-en-2-one, 1-[2-fluoro-4-methyl-5-[(2,2,2-trifluoroethyl)sulfinyl]phenyl]-3-(trifluoromethyl)-1H -1,2,4-Triazol-5-amine and [(3S,4aR,12R,12aS,12b5)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate, 2-cyano-3-(difluoromethoxy)-N,N-dimethylbenzenesulfonamide, 2-cyano-3-(difluoromethoxy)-N-methylbenzenesulfonamide, 2-cyano-3-(difluoromethoxy)-N-ethylbenzenesulfonamide, 4-(difluoromethoxy)-N-ethyl-N-methyl-1,2-benzothiazol-3-amine 1,1-dioxide and N-[1-(2,3-dimethylphenyl)-2-(3,5-dimethylphenyl)ethyl]-4,5-dihydro-1,3-thiazol-2-amine.

2. The composition according to claim 1 wherein said insecticide, acaricide or nematicide of group (A), is selected from the group consisting of Spirotetramat, Thiacloprid, Imidacloprid, Clothianidin, Thiamethoxam, Acetamiprid, Abamectin, Bacillus firmus I-1582, Deltamethrin, L-Cyhalothrin, β-Cyfluthrin, Tefluthrin, Transfluthrin, Fipronil, Chlorantraniliprole, Cyantraniliprole, Flub endiamide, Spino sad, Spinetoram, Sulfoxaflor, and Flonicamid.

3. The composition according to claim 1, wherein the weight or molar ratio of 4-{[(6-chloropyrid-3-yl)methyl](methyl)amino} furan-2(5H)-one and the compound of group (A) is in the range from 200:1 to 1:200.

4. The composition according to claim 1, wherein said composition comprises at least one additional active agrochemically active ingredient.

5. The composition according to claim 4, wherein said additional active ingredient is an insecticide, an acaricide or a nematicide and/or a fungicide.

6. The composition according to claim 1, capable of being used for protecting a seed and/or shoots and/or foliage of a plant emerging from said seed.

7. The composition capable of being used according to claim 6, wherein said seed and/or plant is a conventional and/or a transgenic seed and/or plant.

8. A method for protecting a seed and/or shoots and/or foliage of a plant grown from a seed comprising treating an unsown seed with a composition according to claim 1.

9. The method according to claim 8, wherein 4-{[(6-chloropyrid-3-yl)methyl](methyl)amino} furan-2(5H)-one and the insecticide, the acaricide or the nematicide of group (A) are applied separately onto the seed.

10. The composition according to claim 1, capable of being used for controlling insects, acari and/or nematodes which occur in rice, cotton, tea, vegetables, sugar cane, soybean, potato, top fruits, corn, cereals, vine, ornamentals, rangeland and pastures, oil seed rape, and/or canola.

11. The composition according to claim 5, which comprises a fungicide and is capable of being used for controlling phytopathogenic fungi which occur in rice, cotton, tea, vegetables, sugar cane, soybean, potato, top fruits, corn, cereals, vine, ornamentals, rangeland and pastures, oil seed rape, and/or canola.

12. A method for controlling insects, acari and/or nematodes which occur in rice, cotton, tea, vegetables, sugar cane, soybean, potato, top fruits, corn, cereals, vine, ornamentals, rangeland and pastures, oil seed rape, and/or canola comprising applying a composition of claim 1 to a desired location.

13. A method for controlling phytopathogenic fungi which occur in rice, cotton, tea, vegetables, sugar cane, soybean, potato, top fruits, corn, cereals, vine, ornamentals, rangeland and pastures, oil seed rape, and/or canola comprising applying a composition of claim 5 which comprises a fungicide to a desired location.
